(19) United States
(12) Patent Application Publication
(10) Pub. No.: US 2015/0076865 A1
(43) Pub. Date: Mar. 19, 2015

(54) ANCHORAGE DEVICE

(71) Applicant: GM GLOBAL TECHNOLOGY OPERATIONS LLC, Detroit, MI (US)

(72) Inventors: Bernd Pohl, Muenster-Sarmsheim (DE); Franz-Josef Ringel, Mainz (DE)

(21) Appl. No.: 14/476,510

(22) Filed: Sep. 3, 2014

(30) Foreign Application Priority Data
Sep. 3, 2013 (DE) 202013007803.0

(51) Int. Cl. B60N 2/28

(52) U.S. Cl. CPC B60N 2/289
USPC 296/193.07; 248/503.1

(57) ABSTRACT

An anchorage device for anchoring a portable seat is disclosed. The anchorage device includes a shackle with two legs and a mounting plate equipped with two sockets receiving end of the legs. The shackle and mounting plate are laser welded in such a manner that the legs of the shackle are directly connected to the mounting plate and lie at the most surface-flush with the bottom side of the mounting plate.

### CROSS REFERENCE TO RELATED APPLICATION

This application claims priority to German Patent Application No. 202013007803.0 filed Sep. 3, 2013, which is incorporated herein by reference in its entirety.

### TECHNICAL FIELD

The technical field relates to an anchorage device for anchoring a portable seat on a vehicle seat of a motor vehicle, in particular for anchoring a child seat.

### BACKGROUND

Anchorage devices for the detachable fastening of portable seats, such as for example child seats in motor vehicles are generally known. Accordingly, various child restraint systems for transporting children or infants in motor vehicles exist. In addition to restraint systems, in which exclusively the occupant belt is provided for fastening and fixing child seats, child restraint systems with anchorage devices on the body side are also known. In the case of the so-called “ISOFIX system,” restraint shackles are provided in defined locations of the body, in the region of a motor vehicle seat, for example in the transition from the seat cushion and backrest to which fastening latches provided on the child seat side can be releasably connected.

For improved fastening of child seats individual anchorage devices can also be provided in the region of a parcel shelf located in travelling direction behind the back seat bench, on which a child seat can be fastened, for example by means of a fastening belt. In the case of Sedan versions of motor vehicles, such restraint shackles can be provided in the region of a parcel shelf, while in the case of minivans or Kombi-type motor vehicles such anchorage devices can be integrated fin the back of a backrest part of a motor vehicle seat.

For fastening on the body side, generic anchorage devices include a shackle with two legs, which is welded to a mounting plate that is substantially designed flat. Such a connection of two legs 14, 16 oriented approximately parallel to one another of a shackle on a mounting plate 8 is sketched in FIG. 3. For this purpose, the mounting plate 8 includes two sockets 20 designed as passage opening, through which the free ends of the legs 14, 16 are passed and are welded to the mounting plate 8 on a bottom side 9 of the mounting plate 8 by means of a gas-shielded welding method, for example by means of MIG-welding.

The welding process provided here generates a weld bead 7 encircling the legs 14, 16. To provide an adequately strong and secure connection of the legs 14, 16 to the mounting plate, it is required that the end faces 15 of the two legs 14, 16 projecting downward through the mounting plate 8 have a certain minimum spacing D from the bottom side 9 of the mounting plate 8. Typically, that spacing D amounts to between 5 mm and 10 mm in order to be able to provide an adequately secure connection of the legs 14, 16 to the mounting plate 8 with the gas-shielded welding method provided here.

However, because of the fact that the free ends of the legs 14, 16 projecting downwards protrude from the bottom side 9 of the mounting plate 8 it is required for the connection of such anchorage devices on the body side, to provide corresponding recesses or depressions on a support structure on the body side provided for fastening those anchorage devices, so that the mounting plate 8 with its bottom side 9 can be fastened to the support structure, in particular welded to the same.

Forming such passage openings in the support structure of the body sometimes contributes to a structural weakening of the body. In addition, providing such passage openings requires additional operations and accordingly increased production and assembly effort.

### SUMMARY

In accordance with an embodiment of the present disclosure an improved anchorage device for anchoring portable seats on motor vehicle seats is provided which contributes to an improvement of the structural stiffness of the body, can be mounted particularly cost-effectively, easily and can provide a particularly stable fastening for the portable seat. An anchorage device for anchoring a portable seat, in particular of a child seat or a support shell on a vehicle seat of a motor vehicle is provided. The anchorage device includes a shackle with two legs and a mounting plate. The mounting plate is equipped with two sockets, with which the legs of the shackle are laser-welded. Laser-welding of shackle and mounting plate makes possible a mutual arrangement of shackle and mounting plate in such a manner that the legs of the shackle to be directly connected to the mounting plate no longer protrude from a bottom side of the mounting plate but come to lie at the most surface-flush with the bottom side of the mounting plate.

Such an arrangement of shackle and mounting plate makes possible, furthermore, to largely configure the support structure on the body side for fastening the anchorage device flat or without depression, recess or passage opening. For connecting the anchorage device to the motor vehicle body, the support structure on the body side can be formed passage opening-free so that the body in this region can undergo structural reinforcement. The free ends of the legs of the shackle no longer protrude from the bottom side of the mounting plate because of the laser welding, and the mounting plate furthermore can be connected, in particular welded to the support structure on the body side almost over the full area. In this regard, the laser welding of shackle and mounting plate is also advantageous for a particularly strong, loadable and durable connection of mounting plate and support structure on the body side.

The shackle of the anchorage device is substantially formed U-shaped, wherein the two legs are typically oriented parallel to one another and are approximately identical in length. The sockets for the legs of the mounting plate are spaced from one another, which spacing substantially corresponds to the spacing of the two leg ends.

According to a first embodiment, at least one of the sockets of the mounting plate is formed as a blind hole or as a corresponding depression in the mounting plate. The blind hole can be formed through a bore or through a local stamping of the mounting plate. Advantageously, the bottom side of the mounting plate in this case is substantially formed flat in order to be able to form a mutual contact position on the support structure on the body side preferably over the full area of the mounting plate.

According to a further configuration, at least one of the sockets of the mounting plate is formed as passage opening in the mounting plate. In this way, at least one of the legs can be introduced into or through the passage opening of the mounting plate or be passed through the same and subsequently laser-welded to the mounting plate from a bottom side of the mounting plate, in particular to the inner wall of the passage opening of the socket. The bottom side of the mounting plate in this case corresponds to the sides of the mounting plate facing away from the shackle. The provision of a passage opening in the mounting plate makes possible in particular to connect the leg projecting into the passage opening or projecting through the passage opening to the mounting plate over the entire material thickness of the mounting plate. The thickness of the weld can be maximized in this regard without a welding bead worth mentioning being formed on the top or bottom side of the mounting plate.

It can be provided in particular that both sockets of the mounting plate are formed as blind hole or as passage opening. It is conceivable furthermore to form one of the sockets as a blind hole while the other socket has a passage opening for the corresponding leg of the shackle.

According to a further configuration, the free ends of the legs are arranged with their end faces substantially surface-flush with a bottom side of the mounting plate. In this regard, the legs can close the passage openings provided in the mounting plate substantially over the full area and thus contribute to configuring a substantially flat bottom side of the mounting plate. Laser welding of shackle and mounting plate is particularly well suited for a weld bead-free or weld burr-free configuration of the bottom side of the mounting plate.

The surface-flush arrangement of the legs regarding the bottom side of the mounting plate additionally leads to a direct support of the legs, thus of the shackle on the support structure on the body side when the mounting plate is connected, in particular welded to that support structure in the final assembly state of the motor vehicle. Because of this, direct force transmission from the shackle into the support structure on the body side can be provided.

According to a further configuration, the mounting plate includes a bead-like stamping in the region of at least one of the sockets. The mounting plate is locally formed in that connecting region. Such forming can contribute to the torsional and structural stiffness of the mounting plate and in this regard bring about a structural reinforcement of the mounting plate. As the bead-like stamping extends towards the shackle and in this regard constitutes a recess or a depression relative to the bottom side of the mounting plate, a hollow space can be formed between mounting plate and support structure upon connecting the anchorage device to the support structure on the body side, in which the connecting region of the shackle comes to lie. In this way, it can be made possible in particular when configuring the socket formed as a passage opening so that the free end of the leg or its end face protrudes at least slightly from the bottom side of the mounting plate. Any weld burr or weld bead thus comes to lie in that hollow space in this regard so that through the welded connection of shackle and mounting plate, areal fastening of mounting plate and support structure on the body side is not impaired or only to a negligible degree.

According to a further configuration, the mounting plate has a stamping each in the region of both sockets. A corresponding mounting plate provided with multiple stampings can have an even further improved structural stiffness. The bead-like stampings can be adapted to the geometry or the cross section of the legs or of the shackle. The bead-like stampings can be formed circular but also angular in this regard in the plane of the mounting plate. It is conceivable, furthermore that both sockets for the shackle come to lie within one and the same bead-like stamping.

According to a further configuration, the at least one socket is arranged in the region of a flat bottom portion of the stamping or in the region of such a bead bottom. The bead bottom typically extends parallel to the bottom side of the mounting plate and merges into an angled or sloping bead edge into the bottom side of the support plate which is substantially configured flat. As the at least one socket or as both sockets are arranged in the region of one or multiple bottom portions of one or multiple stampings, the end face of the free end of the leg in each case comes to lie spaced from the support structure of the motor vehicle body. In this way, any welding burrs created during the course of the laser welding can come to lie correspondingly spaced from the support structure.

According to a further configuration, the bottom portion of the stamping is recessed with respect to a substantially flat bottom side of the mounting plate. The bottom portion or bead bottom in this regard is located above the bottom side of the mounting plate projecting downwards. The recessed configuration of the bottom portion with respect to the mounting plate bottom side makes possible in particular the formation of a hollow space between mounting plate and support structure on the body side despite a substantially full-area contact position of mounting plate and support structure.

According to a further configuration, the laser weld of shackle and mounting plate is formed radially between an inner wall of the socket and an outer circumference of the legs. The materially joined connection of leg and mounting plate is located within the material thickness of the mounting plate. For connecting shackle and mounting plate, a laser deep welding process can be provided in particular, which utilizes comparatively high radiation intensities in the region of several megawatt per square centimeter.

In the process, a so-called keyhole can form in the depth of the mounting plate. In the melt formed by the laser beam a vapor capillary is formed in the process in radiation direction of the laser beam, i.e. a hose-shaped hollow space filled with metal vapor or part-ionized metal vapor is formed. By means of a laser deep welding process, the material of the mounting plate, typically steel plate, can be melted in the depth or in the material thickness so that across the entire material thickness of the mounting plate a materially joined connection to the respective leg of the shackle can be created.

According to a further aspect, a motor vehicle body is finally provided which includes at least one support structure, on which at least one anchorage device described before is fastened.

In a further development, the mounting plate of the anchorage device can be welded to the support structure with its bottom side facing away from the shackle. Here, a surrounding welding of mounting plate and support structure is provided in particular in order to provide a particularly stable and durable connection of anchorage device and motor vehicle body.

Through the laser welding of shackle and mounting plate of the anchorage device, the support structure of the motor vehicle body according to a further configuration can be formed passage opening-free in the region of the anchorage device. In this regard, the support structure need not have any passage openings for receiving the leg ends projecting through the mounting plate. Through the omission of such passage openings in the support structure, the dimensional stability of the support structure on the whole can be improved and correspondingly increased.

According to a further configuration, the support structure is formed as a parcel shelf panel or as a cross member of a parcel shelf, which extends approximately adjoining an upper end of a seat backrest of a motor vehicle back seat bench opposite the travelling direction in vehicle longitudinal direction and in vehicle transverse direction. The anchorage device in this case can be formed in particular in a cross member profile portion of the support structure or of the parcel shelf panel. For the individual seats of the motor vehicle back seat bench, at least one previously described anchorage device each can be arranged based on the vehicle transverse direction (y) approximately in the middle regarding the respective seat.

After all that a vehicle is finally provided which includes a motor vehicle body described before and/or at least one anchorage device described before.

### BRIEF DESCRIPTION OF THE DRAWINGS

The present disclosure will hereinafter be described in conjunction with the following drawing figures, wherein like numerals denote like elements.

FIG. 1 shows a support structure on the body side designed as a parcel shelf panel;

FIG. 2 shows a perspective representation of an anchorage device according to a first configuration;

FIG. 3 shows a cross section through a conventional anchorage device in the region of the shackle connection to a mounting plate;

FIG. 4 shows a further configuration of the anchorage device in cross section; and

FIG. 5 shows a schematic representation of a motor vehicle equipped with the anchorage device.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

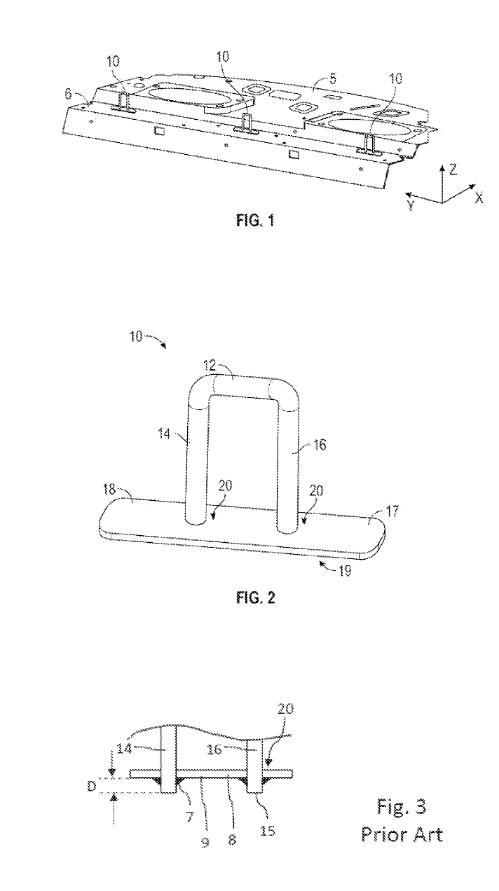

The anchorage device 10 shown in perspective representation in FIG. 2 includes a shackle 12 formed approximately U-shaped, which has two legs 14, 16 substantially running parallel to one another. The free ends of the legs 14, 16 projecting downwards in FIG. 2 are inserted in the sockets 20 sketched in FIG. 2 of a mounting plate 18 substantially falls flat and laser-welded there to the mounting plate 18. Through a laser welding process, the formation of welding beads or welding burrs on the top side 17 and also on the bottom side 19 of the mounting plate 18 can be largely avoided.

In a final assembly configuration, such as is schematically shown for example in FIG. 1, the anchorage device 10 shown in FIG. 2 can be arranged on a cross member profile portion 6 of a support structure 5 located in travelling direction at the front via the mounting plate 18, in particular welded to the cross member profile portion 6. The support structure 5 on the body side schematically shown in FIG. 1 is configured as a parcel shelf panel, which extends approximately from the upper end of a backrest of a rear seat bench of the motor vehicle against the travelling direction, in the plane substantially defined by vehicle longitudinal direction (x) and vehicle transverse direction (y).

As shown in FIG. 1, multiple anchorage devices 10 approximately spaced equidistantly in vehicle transverse direction (y) are arranged on the cross member profile portion 6 of the support structure 5.

By laser welding shackle 12 and mounting plate 18, a substantially flat bottom side 19 of the mounting plate or of the anchorage device 10 without elevations can be formed, which makes possible supporting and resting of the mounting plate 18 on the support structure 5 on the body side over a largely full area.

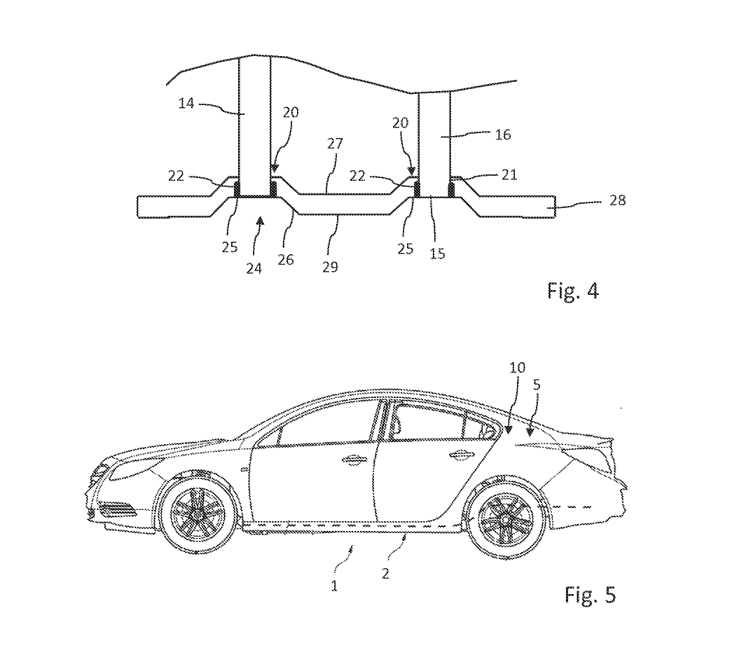

In the embodiment shown in cross section in FIG. 4, the mounting plate 28 is provided with a bead-like stamping 24 each in the region of the connection of the two legs 14, 16 of the shackle 12. The stamping 24 is recessed with respect to the bottom side 29 of the mounting plate 28. The stamping 24 thus projects upwards and extends to the upper portion of the shackle 12 which is configured closed. The stamping 24 has a bottom portion 25, which extends substantially parallel to the bottom side 29 of the mounting plate 28. That bottom portion 25 furthermore is formed substantially flat. Furthermore, the bottom portion 25 into the adjoining bottom side 29 of the mounting plate 28 substantially configured flat via a stamping edge 26 which follows a sloping or inclined course.

The sockets 20 for the free ends of the legs 14, 16 in this case are formed as passage openings. The legs 14, 16 are inserted into those sockets 20 in such a manner that the end faces 15 of the legs 14, 16 projecting downwards come to lie substantially surface-flush with the bottom portion 25 of the stamping 24. The weld 22 for the materially joined connection of shackle 12 and mounting plate 28 extends radially adjoining or radially between the outer circumference of the legs 14, 16 and the inner wall 21 of the sockets 20. Typically, the weld 22 or the region of the mounting plate 18 or of the shackle 12 melted through the laser welding process extends approximately over the entire material thickness of the mounting plate 28.

The forming of the stamping 24 on the one hand can improve and accordingly reinforce the structural stiffness of the mounting plate 28. In addition, through the stamping 24, a hollow space is formed between the bottom portion 25 and the top side of the support structure 5 so that any welding burrs or welding beads which are invariably created through the welding process project from the bottom portion 25 downwards remain contact-free regarding the support structure 5 when the mounting plate 28 is welded to the support structure 5 with its bottom side 29.

The shackle 12 as well as the mounting plates 18, 28 are typically produced from steel or a steel plate. The extension of the weld 22 between shackle 12 and mounting plate 28 and 18 respectively can be at least 50%, at least 75%, at least 85%, 95% or even 100% of the material thickness of the mounting plate 18 and 28 respectively in the direction of the surface normal of the mounting plate 28, 18. In configurations, in which the extension of the weld 22 is smaller than the material thickness of the mounting plate 18, 28, the top side of the mounting plate 17, 27 in particular when the bottom side 19, 29 is exposed to laser radiation, can remain largely unworked, so that the type of the weld or the mutual fastening of shackle 12 and mounting plate 18, 28 in the final assembly state is not noticeable on the support structure 5 on the body side.

FIG. 5 finally shows a motor vehicle 1 with a motor vehicle body having at least the support structure 5 provided with multiple anchorages 10 in FIG. 1.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. An anchorage device for anchoring a portable seat on a vehicle seat of a motor vehicle comprising:
a shackle having a first leg terminating at a first end, a second leg terminating at a second end and a middle portion interconnecting the first and second legs; and
a mounting plate having two sockets formed therein including a first socket receiving the end of the first leg and a second socket receiving the end of the second leg, wherein the first and second legs are laser-welded to the mounting plate.

16. The anchorage device according to claim 15, wherein at least one of first and second sockets is formed as a blind hole.

17. The anchorage device according to claim 15, wherein at least one of the first and second sockets is formed as a passage opening in the mounting plate.

18. The anchorage device according to claim 15, wherein the ends of the first and second legs are arranged with their end faces substantially surface-flush with a bottom side of the mounting plate.

19. The anchorage device according to claim 15, wherein the mounting plate has a stamping in the region of at least one of the first and second sockets.

20. The anchorage device according to claim 19, wherein the socket is formed in the region of a flat bottom portion of the stamping.

21. The anchorage device according to claim 19, wherein the mounting plate has a stamping in the region of the first socket and the second socket.

22. The anchorage device according to claim 21, wherein the bottom portion is recessed relative to a substantially flat bottom side of the mounting plate.

23. The anchorage device according to claim 21, wherein the socket is formed in the region of a flat bottom portion of the stamping.

24. The anchorage device according to claim 23, wherein the bottom portion is recessed relative to a substantially flat bottom side of the mounting plate.

25. The anchorage device according to claim 15, wherein the laser weld is formed radially between an inner wall of the socket and an outer circumference of the ends of the legs.

26. A motor vehicle body in combination with an anchorage device comprising:
a support structure;
a mounting plate fastened to the support structure, the mounting plate having a first socket and a second socket formed therein; and
a shackle having a first leg terminating at a first end received in the first socket, a second leg terminating at a second end received in the second socket, and a middle portion interconnecting the first and second legs;
wherein the first and second legs are laser-welded to the mounting plate.

27. The motor vehicle body according to claim 26, wherein the mounting plate is welded to the support structure with a bottom side thereof facing the shackle.

28. The motor vehicle body according to claim 26, wherein the support structure in the region of the anchorage device is formed passage opening-free.

29. The motor vehicle body according to claim 26, wherein the support structure comprises a parcel shelf panel.
